(19) United States
(12) Patent Application Publication
(10) Pub. No.: US 2011/0296613 A1
(43) Pub. Date: Dec. 8, 2011

(54) MEDICAL TABLE WITH A SUPPORT BOARD

(76) Inventors: Kerstin Farmbauer, Pressath (DE); Dieter Heinl, Erbendorf (DE); Hans Liegl, Erlangen (DE); Matthias Müller, Kemnath (DE)

(21) Appl. No.: 13/156,041

(22) Filed: Jun. 8, 2011

(30) Foreign Application Priority Data
Jun. 8, 2010 (DE) 10 2010 023 033.2

(51) Int. Cl. A61G 7/00; A61G 13/00; A47C 21/04

(52) U.S. Cl. 5/600; 5/601

(57) ABSTRACT

The present embodiments provide a medical table with a support board, into which measurement devices are integrated. The measurement devices enable an expansion of the support board caused by a weight load to be determined. The measurement devices include carbon fibers.

### BACKGROUND

This application claims the benefit of DE 10 2010 023 033.2, filed Jun. 8, 2010.

The present embodiments relate to a medical table with a support board for supporting patients during medical examinations.

Medical tables may be used as patient support tables for supporting patients during medical examinations or during operative interventions. The patient support tables are known and used, for example, in connection with X-ray devices, computed tomography devices, magnetic resonance devices or angiography devices. In a computed tomography examination, the patient may be supported on a board that projects beyond the table (e.g., a height-adjustable table) and is adjustable in the longitudinal direction. The weight of the patient causes the support board to bend, which has an adverse effect on the precision of the imaging method demanded in radiation therapy. In order to adhere to the predetermined tolerance limits for the patient position, a known approach is to strengthen the support board. Such reinforcements additionally influence a beam path in an examination area in an X-ray system and thereby adversely affect the quality of the imaging method. Another option for increasing the stability of the board is modified mass distribution (e.g., profiling or hollow-design bars of the board). An uneven mass distribution within the board increases the danger of artifacts during image recording (e.g., with computed tomography imaging). The two approaches to solving the problem are associated with high development and manufacturing costs.

A medical table with a table plate and at least one measuring device is known from DE 10 2007 059 520. The at least one measuring device measures an undesired inclination of the table plate generated by a weight load or as a result of installation. The value of the measured inclination is used for automatic inclination compensation of the tabletop or to set a predefinable inclination of the tabletop. This compensates for the components of an undesired weight force causing the inclination.

### SUMMARY AND DESCRIPTION

The present embodiments may obviate one or more of the drawbacks or limitations in the related art. For example, a medical table, with which deformations caused by a weight load are measurable, may be specified.

The present embodiments provide a medical table with a support board, in which integrated measurement devices are arranged. The measurement devices may determine an expansion (e.g., distortion) of the support board caused by a weight load. In one embodiment, the measurement devices include carbon fibers. The advantage of the present embodiments is that, by determining the expansion of the support board, a simpler determination of deformation is possible.

In one embodiment, the medical table may include a deformation determination unit that determines, from the measured expansion, a precise deformation of the support board. This may enable a position of a patient supported on the support board to be determined. This helps achieve the imaging method precision for radiation therapy.

The deformation of the support board may be produced by an inclination or by a bending of the support board.

In one embodiment, an automatic inclination compensation may be determined from the determined deformation of the support board, or a setting of a predeterminable inclination of the support board may be determined. The advantage of this is that a precise horizontal alignment of the patient on the support board may be undertaken.

In one embodiment, the medical table may include a weight determination unit, via which the weight of the weight force is determined from the measured expansion of the support board. The determined weight of the weight force may be used within the framework of the diagnosis generation as well as in the subsequent therapy method.

A temperature of the support board may also be determined with the measurement devices.

In one embodiment, the medical table may include a temperature determination unit that determines a temperature of the weight load from the measured temperature of the support board. The temperature of the weight load may be used within the context of diagnosis generation as well as in the subsequent therapy method.

In one embodiment, the support board of the medical table may be heatable by the measurement devices. This may enable a comfortable temperature to be provided for a patient supported on the support board.

The measurement devices may include carbon fibers. Carbon fiber-based measurement devices achieve a transparency of the support board for electromagnetic radiation. The X-ray transparency of the support board is retained. The carbon fibers may also be used for heating the support board.

In one embodiment, the medical table may be used for X-ray devices, computed tomographs, magnetic resonance devices or angiography devices. The use of the medical table of the present embodiments contributes to achieving high accuracy in the imaging method.

### BRIEF DESCRIPTION OF THE DRAWINGS

FIG. 1 shows one embodiment of a medical table with a measurement device integrated into a support board of the medical table; and

FIG. 2 shows one embodiment of an arrangement of measurement devices in a support board of the medical table.

### DETAILED DESCRIPTION OF THE DRAWINGS

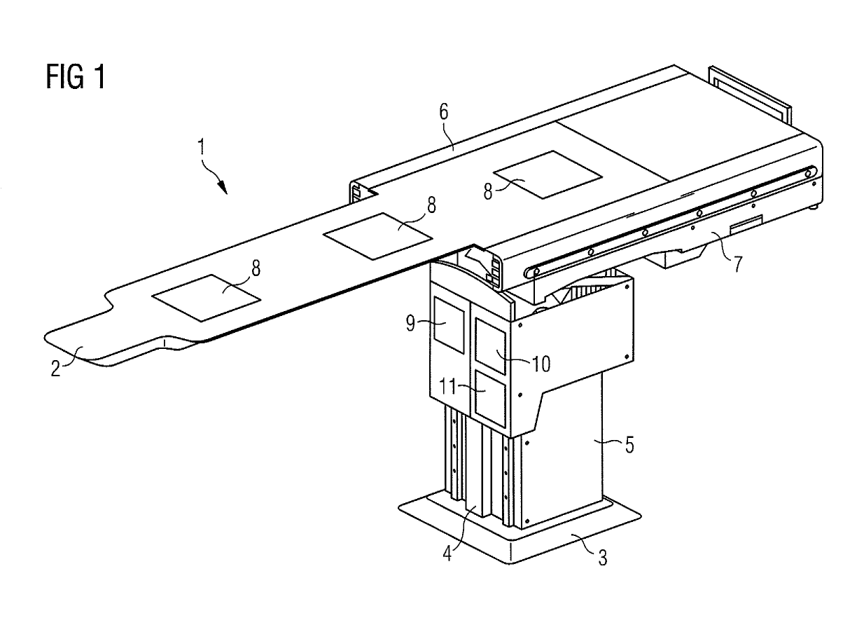

FIG. 1 shows one embodiment of a medical table 1 with a support board 2. The support board 2 rests on a longitudinal carriage 6 and a transverse carriage 7 and is movable with the longitudinal carriage 6 and the transverse carriage 7 in parallel to a floor surface. The longitudinal carriage 6 and the transverse carriage 7 are attached to a table foot 5 that includes a height-adjustment unit 4 for raising and lowering the support board 2. The table foot 5 sits on a rotational support on a floor fixing unit 3. The floor fixing unit 3 provides a rigid and stable connection between the medical table 1 and a floor.

Measurement devices 8 are integrated into the support board 2. The measurement devices 8 enable an expansion of the support board 2 caused by a weight load (not shown in FIG. 1) to be determined. Expansion measurement strips for detecting expandable deformations may be used as the measurement devices 8, for example. Electrical resistances of the expansion measurement strips change in the event of even slight deformations and are thus employed as expansion sensors. In one embodiment, the expansion measurement strips are glued with adhesive to components that deform under load.

A deformation of the support board 2 is determined from the measured expansion via a deformation determination unit 9 arranged in the medical table 1. The bending may be, for example, compensated for by tilting the support board 2. With a corresponding plurality and arrangement of measurement devices 8 in the support board 2, deformations in other areas of the support board 2 may also be determined.

The weight of the weight load is determined via a weight determination unit 10 arranged in the medical table 1 from the measured expansion of the support board 2.

A temperature of the support board 2 may also be determined using the measurement devices 8 integrated into the support board 2. A temperature of the weight load is determined from the measured temperature of the support board 2 via a temperature determination unit 11 arranged in the medical table 1.

In one embodiment, the measurement devices 8 integrated into the support board 2 are suitable for heating the support board 2.

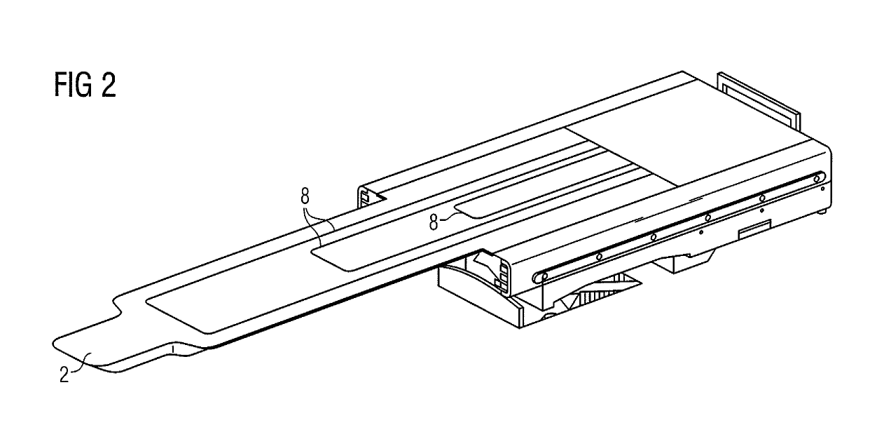

FIG. 2 shows one embodiment of an arrangement of measurement devices 8 based on carbon fiber in the support board 2 of the medical table 1. Integrated into the support board 2 are carbon fiber-based measurement devices 8. An expansion of the support board 2 by a weight load leads to an expansion of the carbon fibers, which causes an electrical resistance of the individual carbon fibers to alter differently. By detection of the expansion at different points of the support board 2, a bend line of the support board 2 may be determined. On the basis of the bend line of the support board 2, an automatic inclination compensation of the support board 2 may be carried out.

For temperature determination using carbon fiber-based measurement devices 8, one temperature may be measured per carbon fiber. This corresponds to an average of all temperatures along the fiber. By using a number of fibers and corresponding mathematical logical combination of the measured temperatures, the temperatures at different points along the support board 2 may be determined.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A medical table comprising:
a support board; and
a measurement device arranged in the support board, the measurement device configured for measuring an expansion of the support board caused by a weight load.

2. The medical table as claimed in claim 1, further comprising a deformation determination unit that determines a deformation of the support board from the measured expansion.

3. The medical table as claimed in claim 2, wherein the deformation of the support board comprises an inclination, a bending, or an inclination and bending of the support board.

4. The medical table as claimed in claim 2, wherein an automatic inclination compensation of the support board or a setting of a predeterminable inclination of the support board is determinable from the determined deformation of the support board.

5. The medical table as claimed in claim 1, further comprising a weight determination unit that determines a weight of the weight load from the measured expansion.

6. The medical table as claimed in claim 1, wherein the measurement device is configured to determine a temperature of the support board.

7. The medical table as claimed in claim 6, further comprising a temperature determination unit configured to determine a temperature of the weight load from the measured temperature of the support board.

8. The medical table as claimed in claim 1, wherein the measurement device is operable to heat the support board.

9. The medical table as claimed in claim 1, wherein the measurement device comprises carbon fibers.

10. A method of using a medical table for X-ray devices, computed tomographs, magnetic resonance or angiography devices, the medical table comprising a support board and a measurement device arranged in the support board, the method comprising:
measuring, using the measurement device, an expansion of the support board caused by a weight load.

11. The medical table as claimed in claim 3, wherein an automatic inclination compensation of the support board or a setting of a predeterminable inclination of the support board is determinable from the determined deformation of the support board.

12. The medical table as claimed in claim 2, further comprising a weight determination unit that determines a weight of the weight load from the measured expansion.

13. The medical table as claimed in claim 3, further comprising a weight determination unit that determines a weight of the weight load from the measured expansion.

14. The medical table as claimed in claim 3, wherein the measurement device is configured to determine a temperature of the support board.

15. The medical table as claimed in claim 4, wherein the measurement device is configured to determine a temperature of the support board.

16. The medical table as claimed in claim 4, wherein the measurement device is operable to heat the support board.

17. The medical table as claimed in claim 5, wherein the measurement device is operable to heat the support board.

18. The medical table as claimed in claim 6, wherein the measurement device is operable to heat the support board.

19. The medical table as claimed in claim 7, wherein the measurement device comprises carbon fibers.

20. The medical table as claimed in claim 8, wherein the measurement device comprises carbon fibers.
